(19) United States
(12) Patent Application Publication
(10) Pub. No.: US 2017/0236145 A1
(43) Pub. Date: Aug. 17, 2017

(54) BUSINESS MODEL AND METHOD OF PUBLICATION USING A PIZZA BOX SPACER

(71) Applicant: Petar Bobrek, Bradenton, FL (US)

(72) Inventor: Petar Bobrek, Bradenton, FL (US)

(21) Appl. No.: 15/429,365

(22) Filed: Feb. 10, 2017

Related U.S. Application Data
(60) Provisional application No. 62/293,947, filed on Feb. 11, 2016.

(51) Int. Cl. G06Q 30/02; G06F 17/30; G06K 19/06

(52) U.S. Cl. CPC G06Q 30/0239; G06Q 30/0201; G06K 19/06037; G06F 17/30879

(57) ABSTRACT

A system having a spacer device for supporting the lid of a pizza box having an indicia such as a QR code. The system including a scanner for scanning the indicia and a communicating device delivering the information to a site. Awards may be delivered to a PDA for use by the consumer.

### CROSS-REFERENCE TO RELATED APPLICATIONS

This application claims priority of U.S. Provisional Application 62/293,947 filed Feb. 11, 2016, the contents of which are incorporated herein by reference.

### FIELD OF THE INVENTION

This disclosure relates to pizza box lid support devices, and more particularly, to a pizza box lid support device for use as a medium for advertisement and promotion and a method of use of the lid support device.

### BACKGROUND OF THE INVENTION

Pizza is a popular food item often ordered for delivery and takeout for social gatherings and sporting events, for example, during sporting events such as football, hockey, soccer and baseball. Advertisers pay significant sums of money for television advertisements during many such events and for banner advertisements visible at the periphery of an arena during play.

A pizza box spacer is typically a small plastic piece of varying shapes with at least three legs standing about 2 to 4 centimeters tall and having a perimeter of 5 to 10 centimeters.

The pizza box spacer is placed in the center of the pizza after the pizza is removed from the oven and placed in a box for takeout or delivery. Its primary purpose is to support the lid of the pizza box to prevent it from coming into contact with the pizza, for example, when multiple boxes are stacked for pickup or delivery.

This centrally located pizza box spacer offers an excellent medium for advertising, and promotional logos, especially considering that an unlimited number of shapes are available to conform with the shape of an advertisement or logo.

Promotional codes or lottery numbers printed on the pizza box spacer logo may be used by an advertiser as a means to entice consumers to register to win cash and prizes in exchange for providing consumer data.

### SUMMARY OF THE INVENTION

The invention relates to a spacer device for supporting a pizza box and a system and a method of use. The spacer device includes a plurality of legs each having a predetermined length generally equal to the distance between the underside of the lid and a pizza, and a planar portion connected to each of the legs, the planar portion having a top surface and an indicia formed on the top surface planar portion. The system includes the spacer with indicia, a scanner for reading the indicia, a device for communicating between the scanner and site. The system can also include a display and the communication device is a two-way communication device providing information about the product to the display. The method of using the pizza box spacer includes the steps of placing an indicia on the top surface of the spacer, scanning the indicia with an electronic device, and accessing a site with the electronic device. The method may also include uploading information regarding the pizza from the site to the electronic device and displaying information on the electronic device. Information displayed may be a coupon for redemption on purchases, or information regarding the consumer may be gathered through the website for measuring consumer response.

### BRIEF DESCRIPTION OF THE DRAWINGS

FIG. 1 is a perspective view of a pizza box, pizza and spacer device;

FIG. 2 is a perspective view of a system having a pizza box lid spacer with indicia and a scanner;

FIG. 3 is a perspective view of a pizza box lid spacer having indicia of a barcode in accordance with the invention; and

FIG. 4 is a flowchart showing the method of use in accordance with the invention.

### DETAILED DESCRIPTION OF THE INVENTION

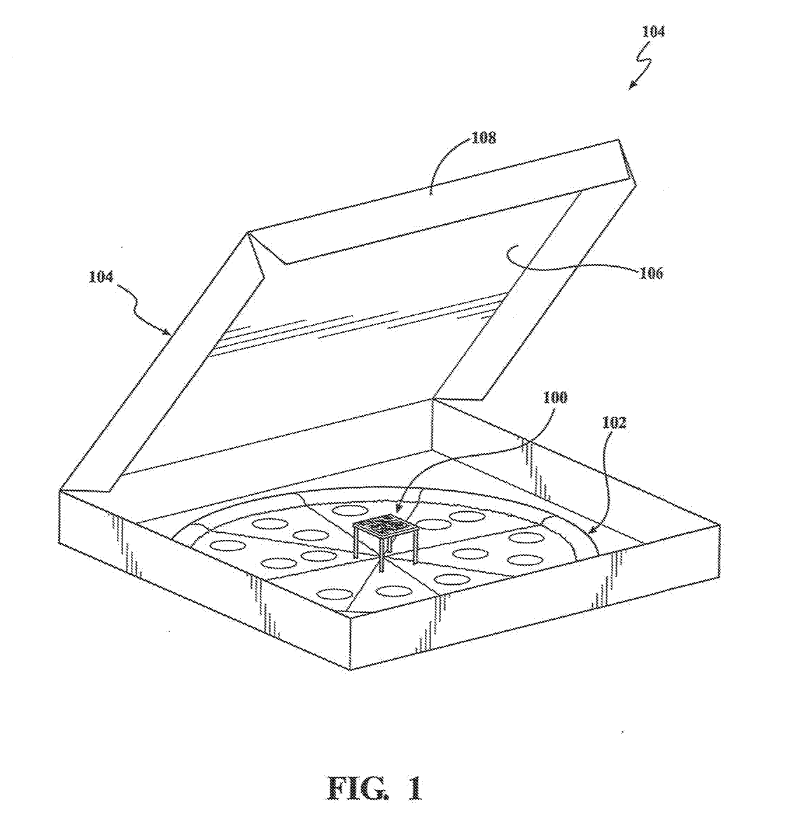

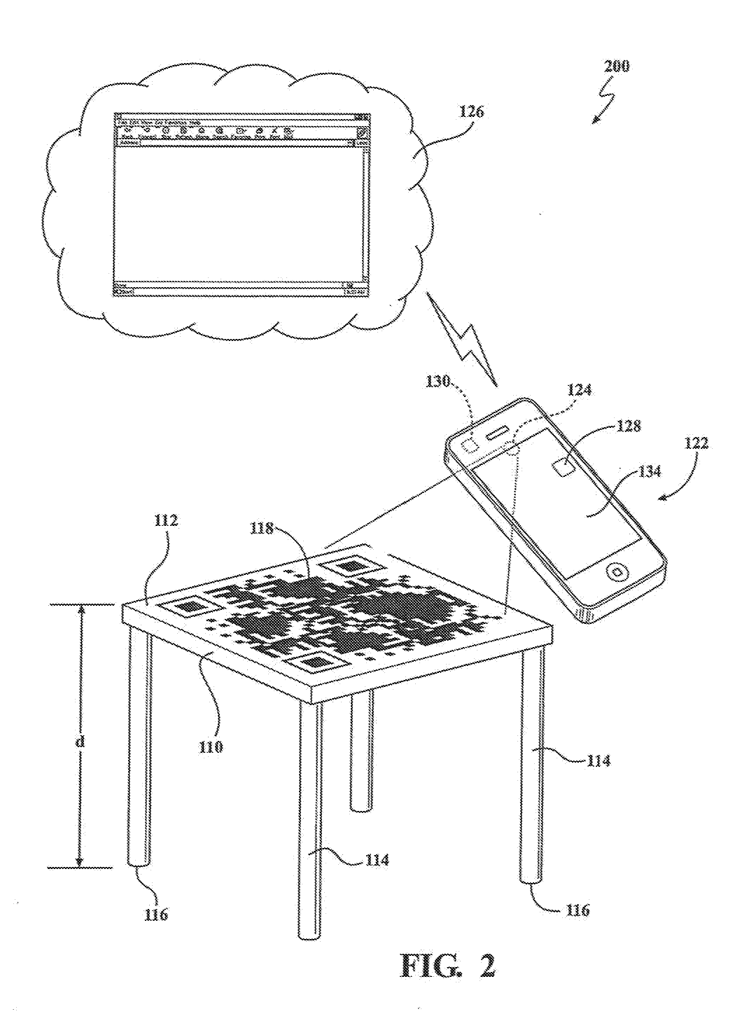

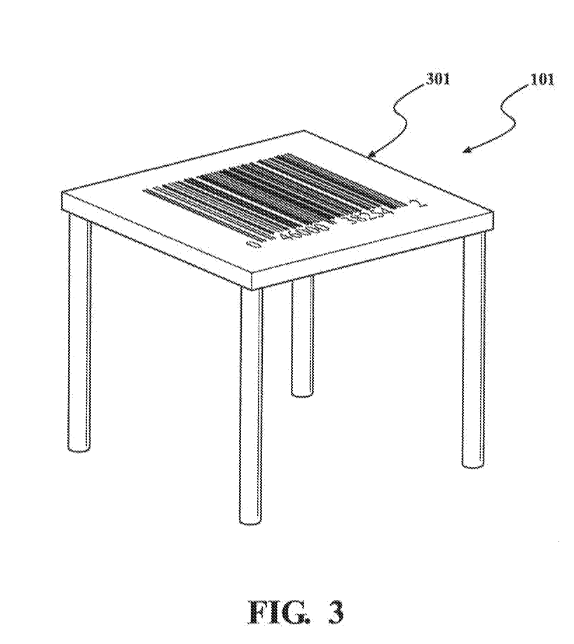

The invention relates to a pizza box spacer device and a system using the spacer device and a method of use. As shown in FIG. 1, a pizza box spacer device 100 is placed on a pizza 102 within a pizza box 104 to prevent the underside 106 of the lid 108 of the pizza box 104 from contacting the pizza 102. As best shown in FIG. 2, the pizza box spacer device 100 includes four legs 114 and a top portion 110 having a top surface 112. The top portion 110 is shown as having a generally square profile that may be any shape such as a circular profile or a profile in the shape of a logo. Although shown with four legs 114, the spacer device may have any number of legs sufficient to support the lid 104 of the pizza box. Each of the legs 114 is formed such that there is a distance “(d)” between the bottom end of the leg 116 and the top surface 112 of the top portion 110. The distance “(d)” is generally equal to the distance between the underside 106 of the lid 108 of the pizza box 104 and the top of the pizza 102. The top surface 112 has an indicia 118. The indicia may be an advertisement, a logo, bar code, quick response QR code or near field communication tag (NFC). As shown in FIG. 2, the indicia is a quick response or QR code. The QR code 118 permits the user to scan the QR code with a smart device 122 having scanner or a QR code reader 124 to obtain additional information from a site 126 as more fully discussed below. As shown in FIG. 3, an alternative embodiment of the invention includes an indicia which is a barcode.

As shown in FIG. 2, the system 200 includes the spacer device 100, the scanner 124 and the site 126. The scanner 124 may be in a smart phone 122 or cash register or other suitable device. An application software 128 is connected by a communication device 130 to the site 126. The communication device 130 may be a one way communication device to permit gathering of information about a sale or a two way communication device that will allow the site to deliver information about the product to a display 134. The information could be a coupon or a consumer survey where the consumer indicated perferences.

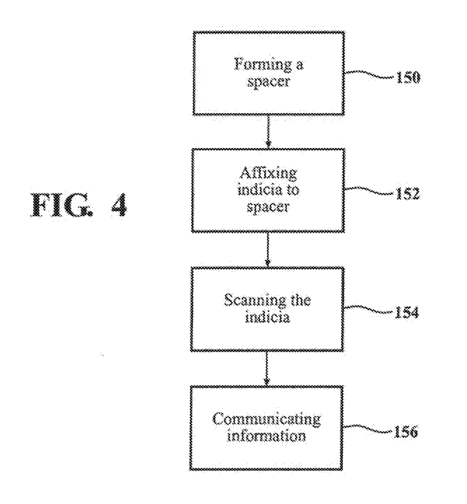

As shown in FIG. 4, the method of use include the steps of forming 150 the spacer device 100 with a top surface and affixing 152 an indicia to the top surface of the spacer device. As mentioned above, the indicia may be a QR code, barcode, NFC Tag advertising, or a logo. The method also includes scanning 154 of the indicia with the scanner and communicating 156 the information by an application contained on a smart device to a site. The software application may be a web browser. Once connected to the site, information from the site may be uploaded to the software application and displayed on the user's device. The information may include product information such as nutritional information, information on the pizza maker, promotional information such as coupons or redemption certificates, and the like. The information may also include location, date and time which are provided by the smart device. The website may also be interactive with a smart device to permit the consumer to provide information about the consumer or an opinion about the quality of the product or services rendered. The information can be used to quantify the number of consumers and when and where they responded from.

The spacer devices can be distributed to pizza vendors under a license agreement for royalties. Alternatively the spaces can be distributed free on the expense covered by revenue from advertisers whose logo or information may be displayed through access to the website.

It will be apparent to those skilled in the art that other variations will be within the scope of the invention as defined by the attached claims.

I claim:

1. A method of using a pizza box spacer device comprising step of;
placing indicia on a top surface of the spacer.

2. The method of claim 1 further comprising the steps of;
scanning the indicia on the spacer with an electronic device;
communication information from the scanner to a site.

3. The method of claim 2 further comprising the step of;
uploading information from the site to the electronic device;
displaying the information on the electronic device.

4. The method of claim 3 wherein the information displayed is a coupon for redemption on purchases.

5. The method of claim 2 further comprising the step of;
gathering information regarding a purchase through the site.

6. The method of claim 5 wherein;
the information gathered is used to measure consumer response.

7. The method of claim 1 further comprising the step of;
providing a circumference of the top surface of the spacer with a shape of logo.

8. A device for supporting a pizza box lid;
the lid having an underside spaced a predetermined distance from a pizza, the device comprising;
A plurality of legs, each of the plurality having predetermined length generally equal to the pre-determined distance between the underside of the lid and the pizza; and
a planar portion connected to each of the plurality of the legs the planar portion having a top surface for supporting the pizza box; and
an indicia formed on the top surface of the planer portion.

9. The device of claim 8, wherein the planar portion has a peripheral shape.

10. A system for using a pizza box spacer; the system including a top surface on the spacer having an indicia;
A scanner for scanning the indicia;
A communication device for communication information from the scanner to a remote site.

11. The system of claim 10 further comprising a display for displaying information from the remote side on a smart phone.

12. The system of claim 10 further comprising a database for storing information received from the scanner for use in analyzing consumer response.
